(19) United States
(12) Patent Application Publication
(10) Pub. No.: US 2024/0217378 A1
(43) Pub. Date: Jul. 4, 2024

(54) DATA LOGGING DEVICE FOR AN ELECTRIC AIRCRAFT

(71) Applicant: ROLLS-ROYCE plc, London (GB)

(72) Inventors: Sivakumar NADARAJAN, Singapore (SG); Viswanathan VAIYAPURI, Singapore (SG); Amit K. GUPTA, Singapore (SG)

(73) Assignee: ROLLS-ROYCE plc, London (GB)

(21) Appl. No.: 18/536,514

(22) Filed: Dec. 12, 2023

(30) Foreign Application Priority Data
Jan. 4, 2023 (GB) 2300050.8

(51) Int. Cl. B60L 53/66; G08G 5/00

(52) U.S. Cl. CPC B60L 53/66; G08G 5/0013

(57) ABSTRACT

A data logging device for an electric aircraft having charging port for on-ground charging of energy storage system of electric propulsion system of aircraft. Device includes an aircraft-side data storage unit, data interface, trigger signal interface, and control unit. Control unit is configured to detect connection of charging port to ground-side charger based on trigger signal received by control unit from ground-side charger via trigger signal interface. Control unit is configured wherein a state of flight of electric aircraft, control unit collects inflight data from electric aircraft via data interface and saves inflight data to aircraft-side data storage unit. Control unit is also configured wherein a state of on-ground charging of electric aircraft, control unit, on receipt of trigger signal, sends inflight data saved on aircraft-side data storage unit via data interface to charger for forwarding to at least one of a data transmitter and a ground-side data storage unit.

### CROSS-REFERENCE TO RELATED APPLICATIONS

This specification is based upon and claims the benefit of priority from United Kingdom Patent Application No. 2300050.8, filed 4 Jan. 2023, the entire contents of which are incorporated herein by reference.

### FIELD OF THE INVENTION

The present invention relates to a data logging device for an electric aircraft.

### BACKGROUND

Interest in aircraft with purely electric and hybrid electric propulsion systems is increasing because of the need to reduce carbon emissions and pollution, and because of developments in the facilitating electrical technologies. Hybrid electric propulsion systems include both internal combustion engines, for example gas turbines or diesel engines, and energy storage, typically in the form of batteries. Purely electric propulsion systems completely dispense with internal combustion engines and use only batteries and/or, in some instances, fuel cells, as an energy source for their propulsors.

Urban Air Mobility (UAM) refers to the use of aircraft—typically purely electric aircraft—to transport passengers relatively short distances, for example tens of kilometres. Most proposed UAM platforms, sometimes known as ‘air taxis’ or ‘flying taxis’, have Vertical Take-Off and Landing (VTOL) or Short Take-Off and Landing (STOL) capabilities so that the aircraft can take-off and land at locations convenient for passengers. Hybrid electric aircraft may have greater ranges.

FIG. 1 illustrates an electric aircraft 10 which may be used for UAM applications. The aircraft includes a fuselage 11, which incorporates a cabin for occupants, and a distributed propulsion system which in this case has six open rotor propulsors 12 driven by rotary electric machines. Also visible in FIG. 1 is a retractable undercarriage 15 in which a landing platform, in this case having wheels, can be stowed during flight.

The size of the fuselage 11 and the cabin will depend on the application requirements, but in this example they are sized for five occupants including a pilot. It is however envisaged that some UAM platforms will not require a pilot and will instead be flown under the control of an autopilot system.

Four of the propulsors 12 are attached to the wings 13 of the aircraft 10, and the remaining two propulsors 12 are attached to a separate flight control surface 14 located towards the rear of the aircraft 10. In this embodiment the wings 13 and the rear control surface 14 are tiltable between a VTOL configuration in which the axes of the rotors point upward and a horizontal flight configuration in which the axes of the rotors point forward. The horizontal flight configuration, whilst principally used for horizontal flight, may also be used for taxiing and possibly STOL operation if supported.

The electrical systems, including the electric machines that power the aircraft 10, receive electrical power from one or more battery packs located within the aircraft. The battery packs may be located in any suitable part or parts of the aircraft, including the fuselage 11, the wings 13 and the propulsors 12.

Whilst the illustrated aircraft 10 is an electric VTOL (eVTOL) aircraft, it will be appreciated that UAM platforms could also be of the STOL type. Hybrid electric platforms may utilize similar distributed propulsion system configurations, but the underlying power system may be a series hybrid, parallel hybrid, turboelectric or other type of hybrid power system.

It would be desirable to perform regular health assessments to identify faults and possible maintenance needs of such aircraft systems. The present invention has been devised in light of this consideration.

### SUMMARY

In a first aspect, the present disclosure provides a data logging device for an electric aircraft having a charging port for on-ground charging of an energy storage system of an electric propulsion system of the electric aircraft, the device comprising an aircraft-side data storage unit, a data interface, a trigger signal interface, and a control unit configured to detect connection of the charging port to a ground-side charger based on a trigger signal received by the control unit from the ground-side charger via the trigger signal interface, wherein the control unit is configured such that: in a state of flight of the electric aircraft, the control unit collects inflight data from the electric aircraft via the data interface and saves the inflight data to the aircraft-side data storage unit, and in a state of on-ground charging of the electric aircraft, the control unit, on receipt of the trigger signal, sends the inflight data saved on the aircraft-side data storage unit via the data interface to the charger for forwarding to the at least one of a data transmitter and a ground-side data storage unit.

Unlike a conventional DLTU, the data logging device does not require a data transmitter and therefore may be simpler than, and have a reduced weight compared to, a conventional DLTU. Furthermore, by excluding a data transmitter the risk that a high-power transmission could interfere with onboard electronics during flight is avoided.

Additionally, there is an advantage that inflight data is sent to the ground-side charger for transmission only while the aircraft is in a state of charging. The charging state of the aircraft is a reliable indicator that the aircraft is grounded and effectively dormant. Therefore, the data logging device does not have to make any complex decisions regarding the timing of the sending of the inflight data to the ground-side charger. Moreover, while the aircraft is charging, other aircraft systems may not transfer data to the data logging device. Therefore, the device may not be required to receive and log data during charging and may solely send saved data. These simplifications can result in a less complex device and therefore lower certification requirements.

Furthermore, the data logging device may advantageously provide a self-contained system. Conventional DLTUs require input from external sensors, such as a WoW sensor, to determine the flight status of the aircraft. This greatly limits the range of electric aircraft that a WoW-configured device may be used in. By contrast, the present data logging device (or wider propulsion system containing the data logging device) may be outfitted to any electric aircraft or electric aircraft airframe.

The control unit may also collect data from the electric aircraft while the aircraft is on-ground but in an active (i.e., non-charging) state, such as taxiing or preparing for take-off, and save this data to the data storage unit for subsequent sending to the ground-side charger for forwarding to the at least one of the data transmitter and the ground-side data storage unit when the aircraft is in a state of on-ground charging.

The data logging device may be configured as a module that is installable or replaceable as self-contained unit from the aircraft.

In a second aspect, the present disclosure provides an electric aircraft having a charging port for on-ground charging of an energy storage system of an electric propulsion system of the electric aircraft, and the data logging device of the first aspect. The data logging device may conveniently be part of the electrical propulsion system, which can be packaged as a single module to be outfitted to the electric aircraft.

In a third aspect, the present disclosure provides a charging station comprising a ground-side charger for connecting to a charging port of an electric aircraft having an energy storage system of an electric propulsion system, and further comprising either or both of a data transmitter and a ground-side data storage unit operatively connected to the ground-side charger, wherein the ground-side charger is configured such that, on connection of the ground-side charger and the charging port of the electric aircraft for charging the energy storage system of the electric aircraft, the ground-side charger also: communicably connects to a data interface and a trigger signal interface of a data logging device of the electric aircraft; sends a trigger signal to a control unit of the data logging device via the trigger signal interface, whereupon the control unit sends inflight data saved on an aircraft-side data storage unit of the data logging device via the data interface to the ground-side charger; and forwards the inflight data to at least one of the data transmitter and the ground-side data storage unit.

In the case that the inflight data is sent to the data transmitter, the inflight data can then be transmitted to a remote receiver. In the case that the inflight data is sent to the ground-side data storage unit, the data can be stored therein for later wired or wireless data transfer, or for subsequent local analysis. As such, the charging station may not require a constant wireless connection and can either store or transmit inflight data as appropriate. Local storage and analysis rather than transmission may be preferred for inflight data containing sensitive information.

The data transmitter of the third aspect may conveniently be a cellular, Wi-Fi or Bluetooth modem or any low power radio transmitter.

In a fourth aspect, the present disclosure provides a combination of the electric aircraft of the second aspect and the charging station of the third aspect, the ground-side charger being connected to the electric aircraft at the charging port.

In a fifth aspect, the present disclosure provides a method for transferring inflight data collected from an electric aircraft, the electric aircraft having a charging port for on-ground charging of an energy storage system of an electric propulsion system of the electric aircraft, the electric aircraft further having an aircraft-side data storage unit for saving inflight data collected during flight of the electric aircraft, the method including: connecting the charging port of the electric aircraft to a ground-side charger to charge the energy storage system; and while the charging port and the ground-side charger are connected, transferring the inflight data saved on the aircraft-side data storage unit to at least one of a ground-side data transmitter and a ground-side data storage unit via the ground-side charger.

When the inflight data is transferred to the ground-side data transmitter, the method may further include transmitting the inflight data from the ground-side data transmitter to a remote receiver.

The data transmitter may conveniently be a cellular, Wi-Fi or Bluetooth modem or any low power radio transmitter.

The invention includes the combination of the aspects and preferred features described except where such a combination is clearly impermissible or expressly avoided.

### BRIEF DESCRIPTION OF THE DRAWINGS

Embodiments and experiments illustrating the principles of the invention will now be discussed with reference to the accompanying figures in which:

FIG. 1 is a perspective view of an electric aircraft in a VTOL configuration; and

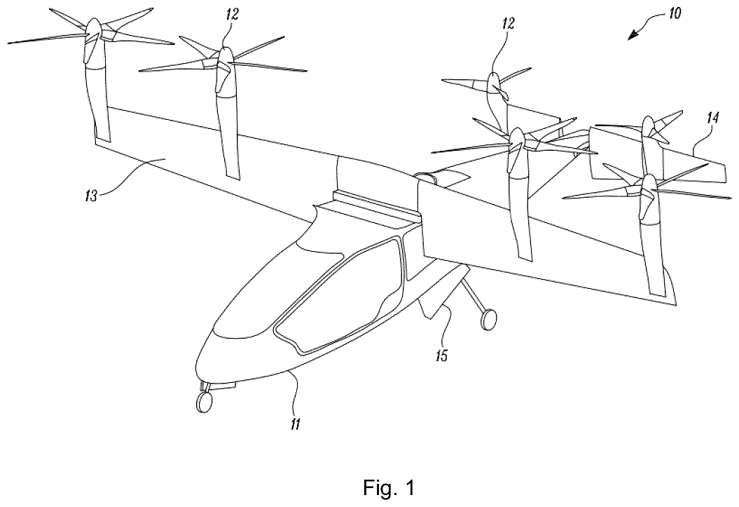

FIG. 2 is a schematic illustration of a charging station and an onboard EPS.

### DETAILED DESCRIPTION

Aspects and embodiments of the present invention will now be discussed with reference to the accompanying figures. Further aspects and embodiments will be apparent to those skilled in the art. All documents mentioned in this text are incorporated herein by reference.

As noted above, it would be desirable to perform regular health assessments to identify faults and possible maintenance needs of such aircraft systems. To this end, electric aircraft may include a Data Logging and Transmission Unit (DLTU). The DLTU logs inflight data relevant to the health of the aircraft and transfers this data to a remote server for analysis. It is convenient that this data is transferred via cellular data, which is a high powered radio transmission. Due to the potential risk of this transmission interfering with the onboard electronics of the aircraft, the DLTU logs data while the aircraft is in flight, but may only transmit this data to a remote receiver while the aircraft is grounded.

To enable the DLTU to switch between these logging and transmission modes, a signal may be required from which the DLTU may determine the flight status of the aircraft. Conventional aircraft may use a Weight on Wheels (WoW) sensor to detect the grounded state of the aircraft and generate a corresponding WoW signal. However, WoW signals have drawbacks with respect to electric aircraft applications. For example, it is increasingly the case that electric aircraft, in particular small electric aircraft, do not have WoW signal capability. A WoW-reliant DLTU package would thus not be able to operate across the full range of new electric aircraft. Moreover, there is an issue that WoW sensors do not provide information as to whether an aircraft is about to take off. Therefore, data transmission reliant on WoW signals may be abruptly terminated on take-off, which may lead to loss or corruption of inflight data.

Additionally, the WoW signal is a continuous signal which fluctuates during landing. WoW-reliant DLTU must read this fluctuating signal and continuously make a decision as to whether or not the aircraft is grounded. To further complicate this decision-making process, there may be a requirement for the DLTU to save the inflight data to a data storage unit (but not to transmit them) in circumstances in which the aircraft is grounded but still active (e.g., while taxiing or preparing for take-off). These two factors increase the complexity of the DLTU logic. An incorrect decision by the DLTU may be detrimental to the integrity of the aircraft components and as such, this complexity results in increased certification requirements. These high certification requirements result in the DLTU having a high production and maintenance cost.

The present invention provides a data logging and transmission device for an electric aircraft that may address one or more of the above drawbacks.

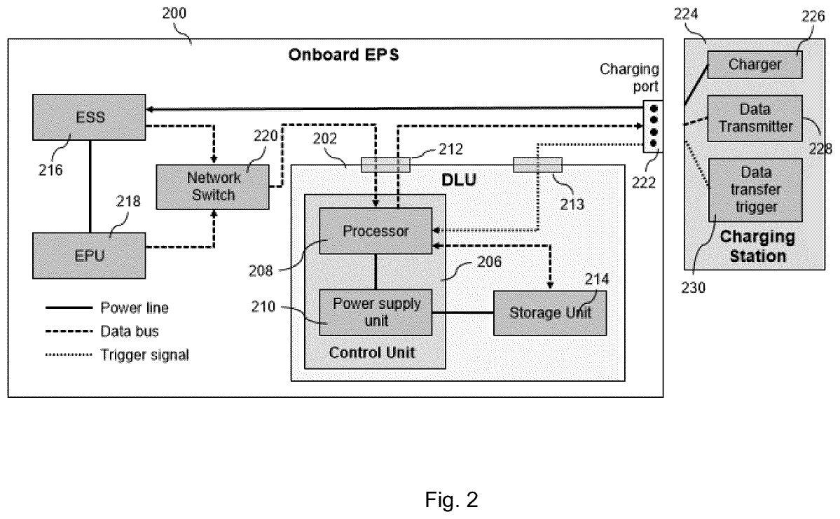

FIG. 2 illustrates an onboard Electrical Propulsion System (EPS) 200 for an electric aircraft and a ground-side charging station 224. The EPS 200 comprises an energy storage system (ESS) 216, an Electric Propulsion Unit (EPU) 218, a network switch 220, a data logging device in the form of a Data Logging Unit (DLU) 202, and a charging port 222. A charger 226 of the charging station 224 may connect to the charging port 222 to transfer electrical energy to the ESS 216. The ESS 216 may comprise one or many batteries, and stores electrical energy that is distributed to the EPU 218 and other aircraft systems (not shown in FIG. 2) during operation. The EPU 218 may comprise multiple electric propulsion assemblies. Each electric propulsion assembly may comprise one or many electric motors and a respective DC:AC converter for each electric motor. While the electric propulsion assembly is in use, the DC:AC converter converts DC power from the ESS 216 to AC signal power for its electric motor. The electric motors are used to propel the electric aircraft and may, for example, be front or rear propulsors. They may tilt while the aircraft is in flight. Both the ESS 216 and the EPU 218 send sensor and other inflight data to the network switch 220. The network switch 220 forwards this data to the DLU 202.

The DLU 202 comprises a data storage unit 214, a control unit 206 further comprising a processor 208 and a power supply unit 210, a data interface 212, and a trigger signal interface 213. The DLU 202 components are powered by the power supply unit 210. During flight, and generally also when the aircraft is grounded but active (e.g., while taxiing or preparing for take-off), data from the network switch 220 is continuously transferred via the data interface 212 to the control unit 206 and thence to the data storage unit 214. Preferably, the DLU 202 is a self-contained module that is installable or replaceable as self-contained unit from the aircraft. The ground-side charging station 224 comprises a charger 226, a data transmitter 228, and a data transfer trigger 230. On connection of the charger 226 and the charging port 222 of the electric aircraft, the data transfer trigger 230 sends a trigger signal to the control unit 206 of the DLU 202 via the trigger signal interface 213. The control unit 206 in return sends inflight data saved on the data storage unit 214 to the charging station 224 via the data interface 212. This data can then be sent to a remote receiver via the data transmitter 228. The data transmitter 228 may conveniently be a cellular modem for transmitting inflight data to a cellular receiver, although the transmitter could alternatively use technologies such as Wi-Fi or Bluetooth to transmit the data. The inflight data is then forwarded by the receiver to a server for analysis. Alternatively, the inflight data received from the DLU 202 by the charging station 224 may be stored in a ground-side data storage unit (not shown) for later transfer to a local or remote device, or for later local analysis.

The data interface 212 and control unit 206 for the DLU 202 thus have two inputs: data from the network switch 220, and the trigger signal from the data transfer trigger 230 of the charging station 224 indicating the charging state of the electric aircraft. When the trigger signal indicates that the aircraft is not in a state of on-ground charging, the control unit 206 can save inflight data received from the network switch 220 to the data storage unit 214. Conversely, when the trigger signal indicates that the aircraft is in a state of on-ground charging, the control unit 206 transfers data saved in the storage unit 214 to the charging station 224 for transmission to the remote receiver.

As the present DLU 202 has no transmitter, any risk of high-power data transmission compromising on-board electronics is avoided. Thus, the DLU 202 has lower certification requirements than a conventional DLTU with a transmission function.

The DLU 202 may also have a reduced weight and reduced energy consumption compared to a conventional DLTU. This is due to the data transmitter 228 being provided within the charging station 224 rather than within the DLU.

Moreover, the DLU 202 can have a low logical complexity. The logging/transmission state of the DLU 202 is dependent only the signal produced by the data transfer trigger 230. This trigger signal may have discrete pulses sent at the initiation and termination of charging to identify the beginning and end of charging, or, conveniently, may be continuously in one state (e.g., “on”) for the duration of charging, and continuously in another state (e.g., “off”) at other times.

Furthermore, the DLU 202 is not dependent on any WoW sensor of the aircraft, instead requiring only the reception of the data transfer trigger signal sent by the charging station 224 to initiate data transfer. The control unit 206 is therefore not required to make a complex logging/transfer decision based on, for example, a continuous WOW signal. The DLU's 202 lack of dependence on a WOW sensor also allows for the unit to be outfitted to a wider range of electric aircraft.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A data logging device for an electric aircraft having a charging port for on-ground charging of an energy storage system of an electric propulsion system of the aircraft, the device comprising: an aircraft-side data storage unit, a data interface, a trigger signal interface, and a control unit configured to detect connection of the charging port of the electric aircraft to a ground-side charger based on a trigger signal received by the control unit from the ground-side charger via the trigger signal interface, wherein the control unit is configured such that:
in a state of flight of the electric aircraft, the control unit collects inflight data from the electric aircraft via the data interface and saves the inflight data to the aircraft-side data storage unit, and
in a state of on-ground charging of the electric aircraft, the control unit, on receipt of the trigger signal, sends the inflight data saved on the aircraft-side data storage unit via the data interface to the ground-side charger for forwarding to at least one of a data transmitter and a ground-side data storage unit.

2. The data logging device of claim 1, wherein at least the control unit, the aircraft-side data storage unit, the data interface and the trigger signal interface of the data logging device are configured as a module that is installable or replaceable as self-contained unit from the aircraft.

3. An electric aircraft having a charging port for on-ground charging of an energy storage system of the electric aircraft and the data logging device of claim 1.

4. A charging station comprising a ground-side charger for connecting to a charging port of an electric aircraft having an energy storage system of an electric propulsion system, and further comprising either or both of a data transmitter and a ground-side data storage unit operatively connected to the ground-side charger, wherein the ground-side charger is configured such that, on connection of the ground-side charger and the charging port of the electric aircraft for charging the energy storage system of the electric aircraft, the ground-side charger also:
communicably connects to a data interface and a trigger signal interface of a data logging device of the electric aircraft;
sends a trigger signal to a control unit of the data logging device via the trigger signal interface, whereupon the control unit sends inflight data saved on an aircraft-side data storage unit of the data logging device via the data interface to the ground-side charger; and
forwards the inflight data to at least one of the data transmitter and the ground-side data storage unit.

5. The ground-side charger for an electric aircraft of claim 3, wherein the data transmitter is a cellular, Wi-Fi or Bluetooth modem.

6. A combination of the electric aircraft of claim 3 and the charging station comprising a ground-side charger for connecting to a charging port of an electric aircraft having an energy storage system of an electric propulsion system, and further comprising either or both of a data transmitter and a ground-side data storage unit operatively connected to the ground-side charger, wherein the ground-side charger is configured such that, on connection of the ground-side charger and the charging port of the electric aircraft for charging the energy storage system of the electric aircraft, the ground-side charger also:
communicably connects to a data interface and a trigger signal interface of a data logging device of the electric aircraft;
sends a trigger signal to a control unit of the data logging device via the trigger signal interface, whereupon the control unit sends inflight data saved on an aircraft-side data storage unit of the data logging device via the data interface to the ground-side charger; and
forwards the inflight data to at least one of the data transmitter and the ground-side data storage unit,
wherein, the ground-side charger being connected to the electric aircraft at the charging port.

7. A method for transferring inflight data collected from an electric aircraft, the electric aircraft having a charging port for on-ground charging of an energy storage system of an electric propulsion system of the aircraft, the electric aircraft further having an aircraft-side data storage unit for saving inflight data collected during flight of the electric aircraft, the method including:
connecting the charging port of the electric aircraft to a ground-side charger to charge the energy storage system; and
while the charging port and the ground-side charger are connected, transferring the inflight data saved on the aircraft-side data storage unit to at least one of a ground-side data transmitter and a ground-side data storage unit via the ground-side charger.

8. The method according to claim 7, wherein the inflight data is transferred to the ground-side data transmitter, the method further including:
transmitting the inflight data from the ground-side data transmitter to a remote receiver.

9. The method of claim 7, wherein the data transmitter is a cellular Wi-Fi or Bluetooth modem.

10. An electric aircraft having a charging port for on-ground charging of an energy storage system of the electric aircraft and the data logging device of claim 2.

11. The ground-side charger for an electric aircraft of claim 10, wherein the data transmitter is a cellular, Wi-Fi or Bluetooth modem.

12. A combination of the electric aircraft of claim 10 and the charging station comprising a ground-side charger for connecting to a charging port of an electric aircraft having an energy storage system of an electric propulsion system, and further comprising either or both of a data transmitter and a ground-side data storage unit operatively connected to the ground-side charger, wherein the ground-side charger is configured such that, on connection of the ground-side charger and the charging port of the electric aircraft for charging the energy storage system of the electric aircraft, the ground-side charger also:
communicably connects to a data interface and a trigger signal interface of a data logging device of the electric aircraft;
sends a trigger signal to a control unit of the data logging device via the trigger signal interface, whereupon the control unit sends inflight data saved on an aircraft-side data storage unit of the data logging device via the data interface to the ground-side charger; and
forwards the inflight data to at least one of the data transmitter and the ground-side data storage unit,
wherein, the ground-side charger being connected to the electric aircraft at the charging port.

13. The method of claim 8, wherein the data transmitter is a cellular Wi-Fi or Bluetooth modem.
